(19) United States
(12) Patent Application Publication
(10) Pub. No.: US 2014/0225456 A1
(43) Pub. Date: Aug. 14, 2014

(54) POWER CONTROL DEVICE

(71) Applicant: FACILITY LABS AB, Taby (SE)

(72) Inventor: David Teppans, Taby (SE)

(73) Assignee: FACILITY LABS AB, Taby (SE)

(21) Appl. No.: 13/767,075

(22) Filed: Feb. 14, 2013

(51) Int. Cl. H01H 43/00

(52) U.S. Cl. CPC H01H 43/00
USPC 307/113; 307/116

(57) ABSTRACT

It is presented a power control device. The device comprises a power input; a power output; a switch arranged between the power input and the power output to thereby control power supply on the power output; a controller connected to the switch, the controller having a signal input; and a timer arranged to run when power is supplied on the power output. The controller is arranged to, when the timer reaches a predetermined value, control the switch to disconnect, and the controller is arranged to, when a heartbeat signal is received on the signal input, reset the timer.

### TECHNICAL FIELD

The invention relates to a power control device.

### BACKGROUND

Electronic devices become more and more complex, both in hardware and software. While reliability of the electronic devices is under continuous improvement, it is still inevitable that at some point, many electronic devices become inoperable.

When such electronic devices become inoperable, they obviously need to be repaired or addressed otherwise. If the electronic device is located in close proximity to operators, an operator can simply go to the electronic device and fix the problem. However, this is more problematic for remote installations, where operators need to travel to gain access to the device.

It is known to use system management protocols, such as SNMP (Simple Network Management Protocol), to remotely connect to electronic devices to both monitor and control them. However this requires both a functioning remote connection and that the electronic device is sufficiently operable to allow remote control.

It would be greatly beneficial if there were a solution which allowed electronic devices to in many cases fix themselves automatically without operator involvement, whether it is on or off site.

### SUMMARY

An object of the invention is to provide a power control device to allow automatic remedy for many fault conditions of electronic devices.

A first embodiment is a power control device comprising: a power input; a power output; a switch arranged between the power input and the power output to thereby control power supply on the power output; a controller connected to the switch, the controller having a signal input; and a timer arranged to run when power is supplied on the power output. The controller is arranged to, when the timer reaches a predetermined value, control the switch to disconnect, and the controller is arranged to, when a heartbeat signal is received on the signal input, reset the timer.

In other words, positive confirmation is required from the external device to ensure continuous power, whereby the power control device does not need to actively check the status of the external device, e.g. by polling. In the case of failure, no heartbeat will be received, whereby the switch is disconnected. The power control device 1 can in this way be kept simple and robust compared to solutions in the prior art.

The power control device may further comprise: a plurality of power outputs, a plurality of switches wherein each switch is arranged between the power input and a respective power output to thereby control power supply on the respective power output; and a plurality of timers, arranged to run when power is supplied on the power output and wherein each timer is associated with a respective switch; wherein the controller is arranged to, when an expiring timer reaches the predetermined value, control the switch associated with the expiring timer to disconnect, and the controller is arranged to, when a heartbeat signal is received on the signal input, reset the timer referred to in the heartbeat signal.

The timer may be arranged to run when the switch is disconnected, and the controller may be arranged to again connect the switch and reset the timer after the timer reaches a second predetermined value. In other words, once the switch is disconnected, the controller will wait a second time period, after which power will again be supplied to the power output. This provides a complete power cycle which can remedy many problems with connected hardware.

The power control device may further comprise an externally visible status indicator.

A second aspect of the invention is a method of controlling power using a power control device. The power control device comprises a power input, a power output, a signal input, a timer and a switch arranged between the power input and the power output. The method is performed in the power control device and comprises the steps of: starting the timer, when a heartbeat signal is received on the signal input, resetting the timer, and when the timer reaches a predetermined value, controlling the switch to disconnect.

The method may further comprise the step of: when the switch has been disconnected, connecting the switch and resetting the timer after the timer reaches a second predetermined value.

It is to be noted that the term timer is to be construed as any software and/or hardware component capable of measuring a time. Furthermore, resetting the timer is to be construed as resetting the timer itself or resetting a pointer to a current time in order to, in subsequent calculations, obtain the same effect as resetting the timer itself.

Generally, all terms used in the application are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram showing a power control device according to one embodiment,

FIG. 2 is a schematic diagram showing a power control device according to a second embodiment,

FIG. 3a is a schematic diagram showing an environment where the power control device of FIG. 1 can be deployed,

FIG. 3b is a schematic diagram showing an environment where the power control device 1 of FIG. 2 can be deployed, and

FIG. 4 is a schematic diagram showing an embodiment of the computer.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

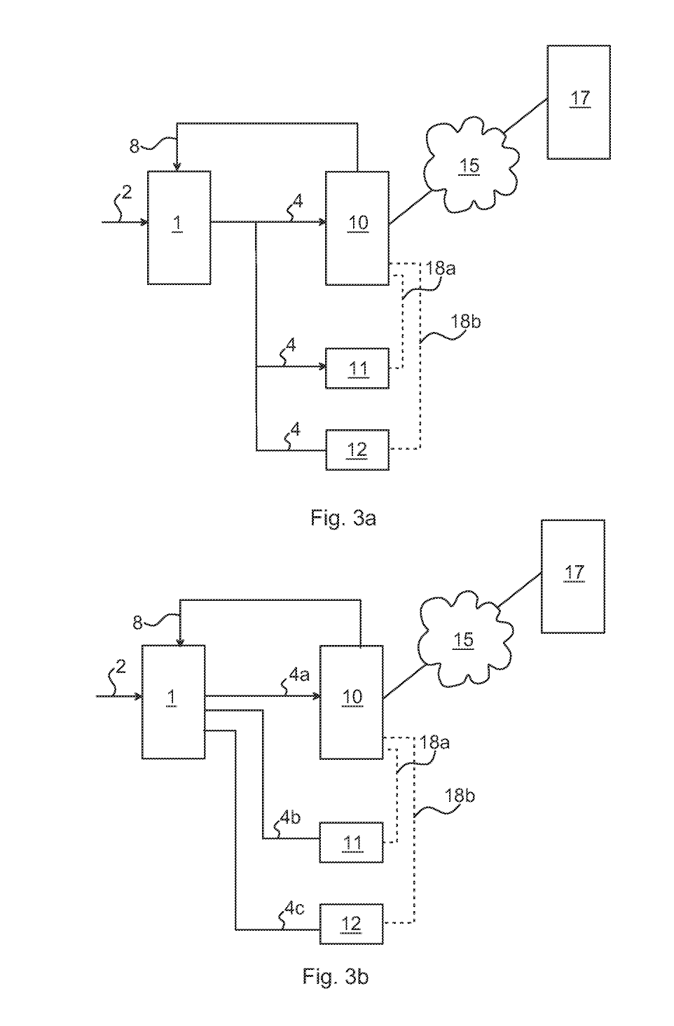

FIG. 1 is a schematic diagram showing a power control device 1 according to one embodiment. The power control device 1 controls whether to connect a power input 2 to a power output 4. The power input 2 and output 4 can for example be 120 volt or 230 volt AC (alternating current) or 12 volt DC (direct current) power, for powering a powered device as will be explained in more detail with reference to FIGS. 3a and 3b below. It is to be noted that other voltages can be used for this invention, as long as the voltage is suitable for powering one or more external devices connected to the power output 4.

A switch 5 is arranged between the power input 2 and the power output 4 to thereby control power supply on the power output 4. When the switch 5 is in a connected state, the power flows through the power control device 1 and is supplied on the power output 4. When the switch 5 is in a disconnected state, the power is unable to flow through the power control device 1 and the power output 4 is powerless.

A timer 7 is connected to a controller 6, which controller 6 in turn is connected to the switch 5. There is furthermore a signal input 8 for external communication to the controller 6 of the power control device 1.

The timer 7 is any module capable of measuring time and that can perform the functions described herein. For example, the timer 7 can be a separate or commonly used hardware component, a software module or a combination of the two.

The signal input 8 can conform to any suitable wireless or wired communication protocol including, USB (universal serial bus), Ethernet, wireless USB, FireWire, IEEE 801.11x, Centronics parallel interface, RS-232 serial interface, etc.

The controller 6 can be any suitable form of digital logic device, including a collection of discrete components, ASIC (Application-specific integrated circuit), FPGA (Field-programmable gate array), microcontroller or a central processing unit (CPU).

Optionally, an externally visible status indicator 3 is provided to convey a current status of the digital logic device and/or power output 4. For example, the externally visible status indicator 3 can be a light emitting diode 3 with different coloured lights and/or blinking patterns. The externally visible status indicator 3 can thus be used e.g. to indicate whether there is power or not supplied to the power output 4.

According to this embodiment, the timer is arranged to capture the time when power is supplied on the power output 4. If the controller 6 determines that the timer 7 expires by reaching a predetermined value, the controller 6 disconnects the switch 5 to thereby disconnect power to any devices connected to the power output 4. This could for example be implemented by means of the timer 7 initially being set to a predetermined value after which the timer 7 decreases its value until it reaches 0, at which point the controller 6 disconnects the switch 5. Alternatively, the controller 6 initially takes note of the value of the timer 7 (which could be, but not necessarily, zero) and when a value of the timer 7 has reached a value which corresponds to the sum of the initial value and the predetermined value, the controller 6 disconnects the switch 5. The predetermined value is set to a suitable value and can optionally be configurable.

However, using the signal input 8, expiry of the timer 7 can be prevented, to thereby ensure continued power supply on the power output 4. This is effected by an external entity sending a heartbeat signal which is received on the signal input 8. After receiving the heartbeat, the controller 6 resets the timer 7 to prevent expiry. This process is typically continued, such that repetitive heartbeats are received on the signal input 8 to ensure continuous power supply on the power output 4. However, if for some reason the heartbeats stop being received, the timer 7 will eventually expire and the controller 6 will disconnect the switch 5.

After a disconnection, the controller 6 waits a second predetermined period, using the timer 7, after which the controller 6 again connects the switch 5 and power is supplied to the output 4. The second predetermined period does not need to have the same length as the first predetermined period. In this way, after a disconnection, power is again supplied to the power output 4, whereby any device connected to the power output 4 is started again. In many cases this resulting power cycle is sufficient to remedy problems of the device connected to the power output 4.

In one embodiment, the external device which is connected to the power output 4 is also responsible for sending heartbeats on the signal input 8. If the external device freezes or becomes inoperable for any other reason, the power control device 1, using the timers, will power cycle the external device. This will in many, if not most, cases remedy the problem and the external device becomes operable once again. Since positive confirmation is required from the external device to ensure continuous power, the power control device 1 does not need to actively check the status of the external device, e.g. by polling. The power control device 1 can in this way be kept simple and robust compared to solutions in the prior art.

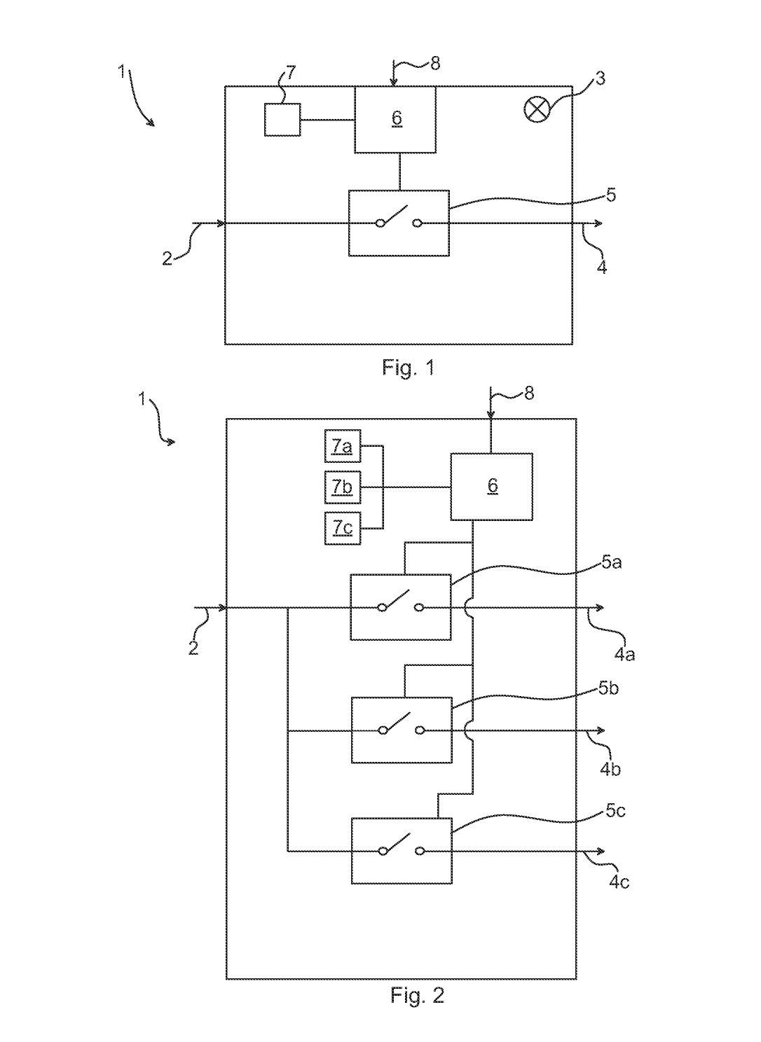

FIG. 2 is a schematic diagram showing a power control device 1 according to a second embodiment. The main difference compared to the power control device 1 of FIG. 1, is the power control device 1 controls a plurality of power outputs 4a-c. The controller uses three timers 7a-c to control three respective switches 5a-c to supply power or not to the three respective outputs 4a-c. Since there is only one controller 6, the heartbeat signals received on the signal input also contain an index indicating which timer to reset. In other respects, each combination of timer 7a-c, switch 5a-c and power output 4a-c works independently from each other as disclosed above with reference to FIG. 1.

It is to be noted that while FIG. 2 illustrates three combinations of power outputs 4a-c with associated timers 7a-c and switches 5a-c, any suitable number of such combinations can be selected.

FIG. 3a is a schematic diagram showing an environment where the power control device 1 of FIG. 1 can be deployed. Here, the power output 4 of the power control device is connected to a computer 10 and, in this example, two peripherals 11, 12. The computer is connected to the peripherals 11, 12 via respective signal links 18a, b, e.g. USB, FireWire, etc. The computer 10 is further optionally connected to a wide area network 15 such as the Internet, whereby the computer 10 can communicate with a system management computer 17. During normal operation, the computer 10 repetitively sends heartbeat signals to the signal input 8 of the power control device 1 to ensure continuous supply of power to the power output 4. While there are two peripherals disclosed herein, any suitable number of peripherals can be used.

A couple of scenarios will now be disclosed to illustrate the usefulness of the power control device 1.

In a first scenario, the computer 10 malfunctions and becomes inoperable. The computer 10 is thus unable to send any more heartbeat signals to the power control device 1. The timer of the power device will expire and disconnect power to the power output 4, shutting off the computer 10 (and the peripherals 11, 12). After a second period, power will again be supplied to the power output 4, allowing the computer 10, and peripherals 11, 12, to boot up. Once the computer 10 has started, heartbeat signals will again be sent, whereby power supply on the power output 4 is ensured.

In a second scenario, the peripheral device ii has become inoperable. This is detected by the computer 10 using the signal link 18a. In this example, the computer 10 is arranged to reboot the computer 10 and peripherals 11, 12 if any of the peripherals becomes inoperable. Hence the computer 10 stops sending heartbeats, leading the power control device 1 to power cycle the computer 10 and the peripherals 11, 12 as in the first scenario.

In a third scenario, the peripheral device 12 could be a USB modem connected to the computer 10. The USB modem is used for connecting to the Internet, but a USB root hub in the computer freezes. Since the same USB root hub is used for communicating heartbeat signals, no heartbeat signals to the power control device 1 are sent and a power cycle is effected as described above.

In a fourth scenario, the peripheral device 11 is a camera connected to the computer via FireWire. If the camera freezes, this results in images not being transferred to the computer 10. Moreover, the main loop in a program running in the computer then waits at a point to receive an image, whereby no heartbeat signals are sent to the power control device and a power cycle is effected as described above. Hence, if the heartbeat transmission code is included in the main loop of a program in the computer 10, no heartbeats are sent when there are any serious problems causing the main loop to stop. In other words, an inoperable peripheral device can passively affect the computer 10 to prevent sending a heartbeat signal, e.g. by freezing a program loop also containing calls to code to send the heartbeat signal.

In a fifth scenario, a planned reboot occurs of the computer, e.g. running MS Windows. During a late part of the shutdown process, the computer freezes and thus would normally not restart. However, since all user programs have terminated, no heartbeat signals are sent from the computer 10, whereby a power cycle is effected as described above.

FIG. 3b is a schematic diagram showing an environment where the power control device 1 of FIG. 2 can be deployed.

Here, the power control device 1 is capable of controlling multiple power outputs 4-c individually. This allows the computer to control power cycling of individual peripherals 11, 12. For example, if the peripheral device 12 becomes inoperable, the computer 10 becomes aware of this using the signal link 18b. The computer 10 then stops sending heartbeats for the peripheral 12, which will have the effect of the power control device 1 power cycling the peripheral 12. In this way, the computer 10 and the peripheral 11 are not power cycled unless they need to.

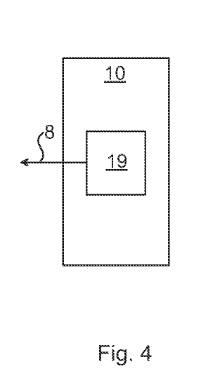

FIG. 4 is a schematic diagram showing an embodiment of the computer 10. The computer 10 is any suitable digital apparatus capable of executing instructions. For example, the computer can be a microcontroller, a personal computer, a server a laptop computer a mobile phone etc. In any case, the computer 10 comprises a control module 19 capable of sending heartbeats on the signal input 8 of the power control device 1. The control module can be implemented using hardware and/or software.

The computer 10 can be embedded in other electronic or electric devices or systems that benefit from robust system management, such as fan systems, servers, surveillance systems, advertisement displays, etc.

The invention has mainly been described above with reference to a few embodiments. However, as is readily appreciated by a person skilled in the art, other embodiments than the ones disclosed above are equally possible within the scope of the invention, as defined by the appended patent claims.

1. A power control device comprising:
a power input;
a power output;
a switch arranged between the power input and the power output to thereby control power supply on the power output;
a controller connected to the switch, the controller having a signal input; and
a timer arranged to run when power is supplied on the power output;
wherein the controller is arranged to, when the timer reaches a predetermined value, control the switch to disconnect, and the controller is arranged to, when a heartbeat signal is received on the signal input, reset the timer.

2. The power control device according to claim 1, further comprising:
a plurality of power outputs,
a plurality of switches wherein each switch is arranged between the power input and a respective power output to thereby control power supply on the respective power output; and
a plurality of timers, arranged to run when power is supplied on the power output and wherein each timer is associated with a respective switch;
wherein the controller is arranged to, when an expiring timer reaches the predetermined value, control the switch associated with the expiring timer to disconnect, and the controller is arranged to, when a heartbeat signal is received on the signal input, reset the timer referred to in the heartbeat signal.

3. The power control device according to claim 1, wherein the timer is arranged to run when the switch is disconnected, and the controller is arranged to again connect the switch and reset the timer after the timer reaches a second predetermined value.

4. The power control device according to claim 1, further comprising an externally visible status indicator.

5. A method of controlling power using a power control device comprising a power input, a power output, a signal input, a timer and a switch arranged between the power input and the power output, the method being performed in the power control device and comprising the steps of:
starting the timer,
when a heartbeat signal is received on the signal input, resetting the timer, and
when the timer reaches a predetermined value, controlling the switch to disconnect.

6. The method according to claim 5, further comprising the step of:
when the switch has been disconnected, connecting the switch and resetting the timer after the timer reaches a second predetermined value.
